(19) United States
(12) Patent Application Publication
(10) Pub. No.: US 2025/0308013 A1
(43) Pub. Date: Oct. 2, 2025

(54) METHOD, SYSTEM AND COMPUTER PROGRAM FOR THE X-RAY INSPECTION OF A PART

(71) Applicants: CENTRE NATIONAL DE LA RECHERCHE SCIENTIFIQUE (CNRS), PARIS (FR); SAFRAN, PARIS (FR); ECOLE NORMALE SUPERIEURE PARIS-SACLAY, GIF-SUR-YVETTE (FR)

(72) Inventors: Cédric FRAGNAUD, MOISSY-CRAMAYEL (FR); Clément REMACHA, MOISSY-CRAMAYEL (FR); Stéphane ROUX, ROSNY-SOUS-BOIS (FR); Julian BETANCUR, MOISSY-CRAMAYEL (FR)

(73) Assignees: CENTRE NATIONAL DE LA RECHERCHE SCIENTIFIQUE (CNRS), PARIS (FR); SAFRAN, PARIS (FR); ECOLE NORMALE SUPERIEURE PARIS-SACLAY, GIF-SUR-YVETTE (FR)

(21) Appl. No.: 18/864,270

(22) PCT Filed: May 11, 2023
(86) PCT No.: PCT/EP2023/062537

§ 371 Date: Nov. 8, 2024

(30) Foreign Application Priority Data
May 12, 2022 (FR) FR2204535

(51) Int. Cl. G06T 7/00; G01N 23/04; G01N 23/083; G06T 15/08; G06T 15/20

(52) U.S. Cl. CPC G06T 7/001; G01N 23/04; G01N 23/083; G06T 15/08; G06T 15/20; G01N 2223/401; G06T 2207/10116; G06T 2207/30164

(57) ABSTRACT

The invention relates to a non-destructive inspection method based on 3D modelling of a part, comprising: using an x-ray device to acquire images of the part at various projection angles; computing projections based on the images acquired at the various projection angles; in each of multiple iterations: generating simulated projections corresponding to the computed projections, based on a reference model of an external surface of the part and on a vector μ of transformation parameters of the reference model; modifying the vector μ with a view to reducing a discrepancy between the simulated projections and the computed projections; determining a corrected model of the external surface through transformation of the reference model by way of the vector μ resulting from the iterations; determining an effective model of the part by way of the corrected model.

### TECHNICAL FIELD

The field of the invention is that of the non-destructive testing by X-ray radiography of parts, for example aerospace parts such as turbine blades.

### PRIOR ART

Non-destructive testing (NDT) of aerospace parts is an essential component of aircraft operational safety, the purpose of which is to avoid any defect that might cause a malfunction during flight. Among NDT methods, X-ray radiography is distinguished by its ability to display the inside of the part in a relatively non-invasive manner and to resolve details down to the micron scale.

A normalized X-ray radiograph is interpreted as an image of the attenuation of the X-rays on traversing the part, an attenuation itself related to the traversed thickness by a law which is often approximated to an exponential function, as is the case for the Beer-Lambert law.

Tomography consists in the acquisition of one thousand or several thousand radiographs during a rotation, usually complete, of a part for the purpose of computing a complete three-dimensional image of the part. The long acquisition time of these tomographic images leads industrial manufacturers to consider only a limited number radiographic images (in the order of ten) to carry out the material health and dimensional NDT.

The validation of parts by X-ray radiography based on a small number of views is usually done manually: examiners, expert technicians trained in this task, analyze the images searching for any abnormal variation in the gray levels.

However, image artefacts alter these gray levels, making validation uncertain and difficult since, when a small number of images is considered, the image artifacts have a high weight and cannot be disregarded. For acceleration voltages of around 350 keV, typically used to acquire turbine blade images, the artifacts to be treated are essentially beam hardening and Compton scattering.

In addition, inter- and intra-examiner variability exists, reducing the reliability of the validation. Finally, the painstaking analysis of the images by the examiners is arduous and tiring work.

Cëdric Fragnaud et al. CAD-based X-ray CT calibration and error compensation. Measurement Science and Technology, IOP Publishing, vol. 33, n° 6, 065024, (2022) https://iopscience.iop.org/article/10.1088/1361-6501/ac5133 proposes an NDT solution based on the comparison between acquired and simulated radiographic images. This solution makes use of a reference model of the inspected part, typically its CAD computer-assisted design model, to provide an a priori knowledge which can be used to perform a calibration based on the alignment of the acquired and simulated images.

### SUMMARY OF THE INVENTION

The invention has the aim of providing an NDT solution enabling the characterization, with a limited number of radiographic images, of the 3D geometry of a part and its three-dimensional conformity with a high level of reliability.

To do this, the invention makes provision for generating a model of an inspected part giving a better rendering of the actual 3D geometry of the part than a reference model which itself renders an expected geometry of the part. More specifically, the invention makes provision for a method of non-destructive testing of a part based on the volume modeling of the part, comprising:
the acquisition, by an X-ray radiography device, of images of the part from different projection angles;
the computation of projections based on the images acquired from the different projection angles;
at each of several iterations:
   the generation of first simulated projections of the part corresponding to the projections computed based on the images acquired from the different projection angles, based on a reference model of an outer surface of the part and on a vector μ of parameters of transformation of the reference model of the outer surface;
   the determination of a discrepancy between the first simulated projections and the projections computed based on the acquired images;
   the modification of the vector μ for the purpose of reducing said discrepancy;
the determination of a corrected model of the outer surface by transformation of the reference model of the outer surface by means of the vector μ resulting from the iterations;
the determination of an effective model of the part by means of the corrected model of the outer surface.

Certain preferred but non-limiting aspects of this method are as follows:
the generation, at each of the iterations, of the first simulated projections is also done based on a reference model of one or more inner cavities of the part, the vector μ also comprising parameters of transformation of the reference model of the inner cavity or cavities;
it further comprises the determination of a corrected model of the inner cavity or cavities by transformation of the reference model of the inner cavity or cavities by means of the vector μ resulting from the iterations;
the determination of the effective model of the part is also done by means of the corrected model of the inner cavity or cavities;
at each of the iterations:
   the determination of a discrepancy between the first simulated projections and the projections computed based on the acquired images comprises, for each projection angle, the computation of a projection residual corresponding to the discrepancy between the first simulated projection for this projection angle and the projection computed based on the image acquired for this projection angle; and
   the modification of the vector μ comprises:
      for each projection angle, the computation of sensitivity fields of the first simulated projection for this projection angle to a variation of the parameters contained in the vector μ;
      the computation of a corrective vector δμ* as being the vector op minimizing a discrepancy between the projection residuals and the product of Sp multiplied by the sensitivity fields;
      the updating of the vector μ using the corrective vector δμ*;
the computation of the corrective vector δμ* comprises the minimization of the sum over the projection angles of the squared norms of the weighted differences between, for each projection angle, the projection residual computed for this projection angle and the product of op multiplied by the sensitivity fields computed for this projection angle;
each iteration further comprises following the modification of the vector μ:
   the generation of second simulated projections of the part corresponding to the projections computed based on the images acquired from the different projection angles, based on the reference model of the outer surface, on a model of a sub-part number j of interest of the part, on the modified vector μ and on a vector θⱼ of geometrical parameters of the sub-part number j of interest of the part;
   the determination of a discrepancy between the second simulated projections and the projections computed based on the acquired images;
   the modification of the vector δ; for the purpose of reducing said discrepancy;
at each of the iterations:
   the determination of a discrepancy between the second simulated projections and the projections computed based on the acquired images comprises, for each projection angle, the computation of a projection residual corresponding to the discrepancy between the second simulated projection for this projection angle and the projection computed based on the image acquired for this projection angle; and
   the modification of the vector θⱼ comprises:
      for each projection angle, the computation of sensitivity fields of the second simulated projection for this projection angle to a variation of the parameters contained in the vector θⱼ;
      the computation of a corrective vector δθⱼ* as being the vector δθⱼ* minimizing a discrepancy between the projection residuals and the product of δθⱼ multiplied by the sensitivity fields;
      the updating of the vector θⱼ using the corrective vector δθⱼ*;
the computation of the corrective vector δθⱼ* comprises the minimization of the sum over the projection angles of the squared norms of the weighted differences between, for each projection angle, the projection residual computed for this projection angle and the product of δθⱼ multiplied by the sensitivity fields computed for this projection angle;
it further comprises the determination of a corrected model of the sub-part of interest number j by transformation of the reference model of the sub-part of interest number j by means of the vector θⱼ resulting from the iterations, the determination of the effective model of the part being also done by means of the corrected model of the sub-part of interest number j;
the generation of the first simulated projections is furthermore done based on a vector p of parameters characterizing the projection geometry of the acquisition;
it further comprises, by means of a vector of parameters of a model of image artifacts, a correction of artefacts in the projections computed based on the acquired images or a generation of artifacts in the first simulated projections;
it further comprises a validation of the part by means of the effective model of the part;
the validation of the part comprises:
   the generation of third simulated projections of the part corresponding to the projections computed based on the images acquired from the different projection angles, based on the effective model of the part;
   the comparison of the projections computed based on the acquired images and the third simulated projections based on the effective model of the part.

### BRIEF DESCRIPTION OF THE DRAWINGS

Other aspects, aims, advantages and features of the invention will become more clearly apparent on reading the following detailed description of preferred forms of embodiment thereof, given by way of non-limiting example and with reference to the appended drawings in which:

FIG. 1 is a diagram of a system of volume modeling of a part according to a possible embodiment of the invention;

FIG. 2 is a diagram showing different steps of a method of volume modeling of a part according to a possible embodiment of the invention;

FIG. 3 illustrates a possible modeling of a sub-part of interest of drilled hole type.

### DETAILED SUMMARY OF PARTICULAR EMBODIMENTS

The invention relates to a method and a system of non-destructive testing based on the volume modeling of a part having an outer surface and potentially one or more inner cavities. The party is typically, but not necessarily, a part composed of a single material. The part can be made using different manufacturing processes, for example by lost-wax casting or by additive manufacturing. The invention has an application in the non-destructive testing of aerospace parts, typically turbine blades, after their manufacturing or during maintenance operations in order to detect any defects therein which can for example cause a malfunction during flight.

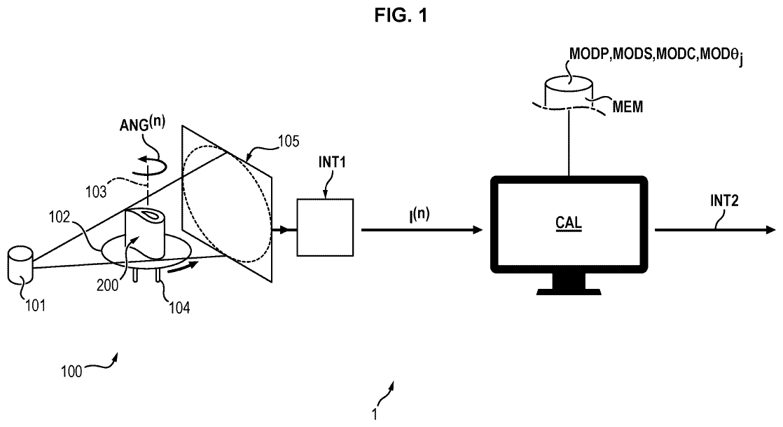

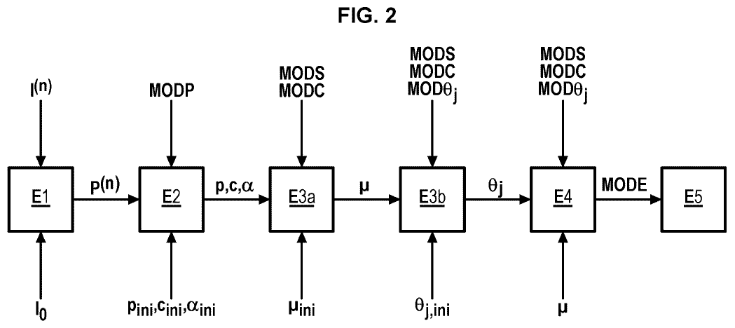

With reference to FIGS. 1 and 2, the volume modeling system 1 includes an X-ray radiography device 100 making it possible to acquire images of an actual part 200 from different projection angles. These images are written I⁽ⁿ⁾ where n denotes the number of one of the projection angles or else one of the views of the part.

The system 1 of non-destructive testing of the part 200 includes, and the method of non-destructive testing of the part 200 uses, one or more electronic control units CAL. The electronic control unit CAL can be or comprise one or more computers, one or more servers, one or more machines, one or more processors, one or more microprocessors, one or more permanent memories MEM, one or more random-access memories MEM. The electronic control unit CAL may comprise one or more physical data input interfaces INT1, one or more physical data output interfaces INT2. This or these physical data input interface or interfaces INT1 may be or comprise one or more computer keyboards, one or more physical data communication ports, one or more touch-sensitive screens, or otherwise. This or these physical data output interface or interfaces INT2 can be or comprise one or more physical data communication ports, one or more screens, or otherwise. A computer program can be recorded and executed on the electronic control unit CAL and include code instructions which, when they are executed on this electronic control unit, implement all or part of the method of volume modeling of the part 200 according to the invention, including the receiving of the images I⁽ⁿ⁾ during step E1.

The X-ray radiography device 100 includes a source 101 of X-rays, a holder 102 on which the part 200 is located, a control mechanism 104 to turn the holder 102 and the source 101 with respect to one another 101 about an axis 103 of rotation, which can for example be vertical (for example the source 101 is fixed and the holder 102 is rotated about the axis 103), a detector 105 of the X-rays traversing the part 200, the part 200 being therefore located on the trajectory of the X-rays between the source 101 and the detector 105. The source 101, the holder 102 and the detector 105 are disposed in a high-power X-ray booth. The detector 105 provides the images I⁽ⁿ⁾ of the part used to compute projections P⁽ⁿ⁾ of the part 200 during a first step E1 of the method according to the invention. The control mechanism 104 is controlled for the acquisition at N projection angles ANG(n), different from one another, of the part 200 in relation to the X-rays, by the detector 105, of N images I⁽ⁿ⁾. N is a stated natural integer, greater than or equal to 1. The natural integer n ranges from 1 to N and denotes the number of the respective projection angle ANG(n) and therefore the number of the acquired image I⁽ⁿ⁾ and of the computed projection P⁽ⁿ⁾. The radiography device 100 thus makes it possible in step E1 to compute N projections P⁽ⁿ⁾ of the volume of the part 200 along the N projection angles ANG(n) respectively. One embodiment of P⁽ⁿ⁾ is P⁽ⁿ⁾=−log(I⁽ⁿ⁾/I₀) where I⁽ⁿ⁾ denotes an image of intensity of the X-rays having traversed the part for the view n and I₀ the blank image (i.e. the image captured by the detector in the absence of any part). The long acquisition time of the images acquired by X-ray leads to only a limited number N of projections P⁽ⁿ⁾ being considered, typically less than 100.

A calibration step E2, subsequent to the first step E1, can be implemented by the electronic control unit CAL in order to identify the parameters of a parametric model describing the formation of the images I⁽ⁿ⁾ and rendering phenomena that occur during the acquisition, such as Compton scattering and beam hardening. This step E2 more specifically aims to estimate parameters representative of the projective geometry of the radiography device 100 and to estimate parameters of a model of expected image artifacts for the constituent material of the part and the power of the X-ray beam used.

This step E2 makes use of a digital reference model MODP of the part as a priori knowledge. This model MODP, which can be stored ahead of time in the memory MEM of the electronic control unit CAL, is a geometrical reference of the part 200, for example a computer-assisted design (or CAD in abbreviated form) model of the part 200, replicating an ideal part 200. This model MODP can take into account the composition of the material of the part 200.

Starting from this digital reference model MODP of the part 200, the electronic control unit CAL can simulate expected radiographs of the part. The electronic control unit can thus generate simulated projections corresponding to the observed projections (i.e. the projections computed based on the acquired images) from the different projection angles. The parameters representative of the projective geometry of the radiography device are taken into consideration during this generation. Moreover, the parameters of the model of image artifacts can be used to replicate the artifacts in the simulated images or correct the artifacts in the acquired images.

The determination of these different parameters can be done following the procedure detailed in the abovementioned article and a brief description of which is given below.

For the estimation of the projective geometry, it is advisable to determine a vector p of projection parameters pᵢ during the acquisition of the images from the different projection angles. For artifacts it is advisable to determine a vector c of beam hardening calibration parameters cₖ of the radiation and a vector α of parameters αⱼ of the effect of the Compton scattering on the images acquired from the different projection angles. The difference or residual ρ⁽ⁿ⁾ between P⁽ⁿ⁾, the projection observed for view n, and \tilde{P}⁽ⁿ⁾, the simulated projection for the view number n, is minimized in relation to the parameters contained in the vectors p, c and α. The following equation sets out the computation of the residual for the view number n: ρ⁽ⁿ⁾(x; p, c, a)=P⁽ⁿ⁾(x)−\tilde{P}⁽ⁿ⁾(x; p, c, α) where x denotes one pixel of the X-ray detector.

The following equation sets out the computation of the digitally simulated projection \tilde{P}⁽ⁿ⁾ using the vectors of parameters p, c and α only. It formalizes how the digitally simulated projection encodes the projection geometry between the booth and the part with the vector p, the beam hardening phenomena with the vector c and the function u, and the Compton scattering phenomenon with the parameter α and the convolution kernel K.

$${\tilde{P}}^{( n )} ( x ; p , c , α ) = u ( {\hat{P}}^{( n )} ( x ; p ) ; c ) * K ( x ; α )$$

with \hat{P}⁽ⁿ⁾(x; p) the simulated projection for the thickness of material traversed in the part for the view number n using the vector p and the reference model of the part MODP, u(y; c) a function defined by the vector c to calibrate the traversed thickness y=\hat{P}⁽ⁿ⁾(x; p) and thus model the radiation beam hardening phenomenon, * the convolution operator, and K(x; a) a convolution kernel at the pixel x. The convolution with the kernel K(x; a) defined by the vector α models the effect of the Compton scattering.

The determination of the parameters contained in the vectors p, c and α making it possible to minimize the residuals can make use of sensitivity fields by following a three-step iterative procedure as described in the abovementioned article, this iterative procedure making use of the initial estimates pᵢₙᵢ, cᵢₙᵢ and αᵢₙᵢ of the vectors p, c and α.

It has previously been seen that the digital reference model MODP represents an ideal part 200. As detailed hereinafter, the system and method according to the invention make it possible to determine a model, called effective model MODE, replicating the actual part more finely and more accurately than the model MODP. In one possible embodiment of the invention this effective model is able to replicate positioning defects between different 3D entities of the part, for example between the outer surface and a sub-part constituting the part, for example an inner cavity or a drilled hole. Given that the variation in shape of the cavities has an effect on the whole part and is the origin of critical shape defects, they are here considered as a special case. Thus, in the following text, a distinction is made between the inner cavities and the other sub-parts, for example the drilled hole.

To do this, the system and method according to the invention consider the 3D geometrical entities making it possible to represent the blade by means of a description of their shapes, their positions and their sizes. More precisely, the steps E3a, E3b and E4 described hereinafter make use of a reference model MODS of the envelope of the part subsequently referred to as the outer surface of the part, for example a CAD model, and, in one possible embodiment, a reference model MODC of one or more inner cavities, for example a CAD model.

These steps can also make use of the models of other sub-parts of interest of the part, for example in the form of deformable CAD models or parametric models. These steps have the aim of estimating the positions, scale factors and deformations affecting the reference model MODP. Where applicable, these steps can also be used to determine the parameters of the models of other sub-parts of interest to characterize their geometry, for example an inner wall characterized by its 3D position and its thickness or else a drilled hole characterized by its diameter and its depth.

Note that it is particularly relevant to separate the outer surface and the inner cavities when the part is the result of manufacturing by lost-wax casting. Specifically, the geometry of the outer surface and that of the inner cavities are then generated by different elements. The outer surface is thus directly related to the metrology of the wax injection mold while the cavities are related both to the metrology of the core and to the system for locking the core in the wax injection mold. In this case, the model MODC may be the core reference model.

In a step E3a, the method according to the invention then estimates a vector μ of parameters of transformation of the reference model of the outer surface and, where applicable, of the reference model of the inner cavity or cavities. Taking the example of a rigid transformation of the reference model of the outer surface and of the reference model of the inner cavity or cavities, six degrees of freedom (three translations and three rotations) are needed to describe the rigid movement of each model. The vector μ therefore comprises twelve components: six for a 3D translation of each reference model and six for the 3D rotation of each reference model, for example via Euler angles or a quaternion.

In an optional step E3b, the method according to the invention then estimates a vector θⱼ of geometrical parameters of a j-th sub-part of interest of the part. This step E3b is repeated for each of the sub-parts of interest when several of them are considered.

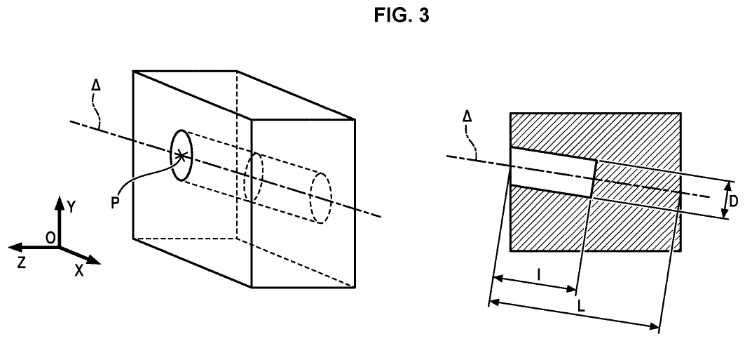

By way of example, FIG. 3 shows a drilled hole in perspective view and a section, one possible modeling of which is that of a cylinder, the shape of which is governed by different geometrical parameters, for example the radius, length and orientation parameters of the axis. These different geometrical parameters of the drilled hole corresponding to the sub-part number j are grouped together in the vector θⱼ.

In the remainder of the text, a joint implementation of steps E3a and E3b is considered. In this context, the invention then determines the column vector μ of parameters of transformation of the reference model of the outer surface and of the reference model of the inner cavity or cavities, and the column vectors θⱼ of geometrical parameters of the different sub-parts of interest. The vectors θⱼ are grouped together in a list θ such that the j-th entry corresponds to the vector θⱼ for the sub-part number j.

The determination of these vectors is done by making use of a difference or residual ρ⁽ⁿ⁾ between P⁽ⁿ⁾ the observed projection of the view n and \tilde{P}⁽ⁿ⁾ the simulated projection for the same view n which is expressed, for example, in the following form when the calibration step E2 has been implemented beforehand: ρ⁽ⁿ⁾(x; p, c, α, μ, θ)=P⁽ⁿ⁾(x)−\tilde{P}⁽ⁿ⁾(x; p, c, α, μ, θ).

One embodiment of \tilde{P}⁽ⁿ⁾ is \tilde{P}⁽ⁿ⁾(x; p, c, α, μ, θ)=u(\tilde{P}⁽ⁿ⁾(x; p, μ, θ); c)*K(x; α), with \hat{P}⁽ⁿ⁾(x; p, μ, θ) the simulated projection of the thickness of material traversed for the view number n using the projection vector p, the models of the part characterized by the vector μ and the models of the sub-parts of interest characterized by the vector θ. The vectors of parameters p, c, α describe the model of the projective geometry and the image artifact model. The function u(y; c) which then corrects the attenuation of the radiation as a function of the traversed length y=\hat{P}⁽ⁿ⁾(x; p, μ, θ) makes it possible to characterize the effect of the radiation beam hardening, and the convolution with the convolution kernel K(x; α) makes it possible to characterize the effect of the Compton scattering. The computation of the optimal vectors p, c, α is described above in connection with the abovementioned article.

The step E3a can follow an iterative process comprising at each of several iterations:
the generation of first simulated projections of the part \tilde{P}⁽ⁿ⁾(x; p, c, α, μ, θᵢₙᵢ) corresponding to the projections computed based on the images acquired from the different projection angles, based on the reference model of the outer surface MODS, where applicable, of the reference model of the inner cavity or cavities MODC and on the vector μ of parameters of transformation of the reference model of the outer surface and, where applicable, of the reference module of the inner cavity;
the determination of a discrepancy between the first simulated projections and the projections computed based on the acquired images;
the modification of the vector μ for the purpose of reducing said discrepancy.

This iterative process makes use of an initial estimate μᵢₙᵢ of the vector μ, taken for example as representative of an identity transformation of the reference models of the outer surface and of the inner cavity or cavities. In the preceding text, θᵢₙᵢ denotes the list containing the values of the geometrical parameters of the different sub-parts of interest in the ideal part.

At each of the iterations, the determination of a discrepancy between the first simulated projections and the projections computed based on the acquired images may comprise, for each projection angle, the computation of a projection residual, for example as ρ⁽ⁿ⁾(x; p, c, α, μ, θᵢₙᵢ)=P⁽ⁿ⁾(x)−\tilde{P}⁽ⁿ⁾ (x; p, c, α, μ, θᵢₙᵢ), corresponding to the discrepancy between the first simulated projection \tilde{P}⁽ⁿ⁾ for this projection angle and the projection P⁽ⁿ⁾ computed based on the acquired image I⁽ⁿ⁾ for this projection angle.

Moreover, at each of the iterations, the modification of the vector μ may comprise:
for each projection angle, the computation of fields of sensitivity of the first simulated projection for this projection angle to a variation of the parameters contained in the vector μ;
the computation of a corrective vector δμ* as being the vector δμ* minimizing a discrepancy between the projection residuals and the product of δμ multiplied by the sensitivity fields;
the updating of the vector μ using the corrective vector δμ*.

The field of sensitivity of a simulated projection to a variation of a parameter μₖ of the vector μ is expressed for example as

$${s}^{( n )} ( x ; {μ}_{k} ) = \frac{\partial {\tilde{P}}^{( n )} ( x ; p , c , α , μ , {θ}_{ini} )}{\partial {μ}_{k}} .$$

The computation of the corrective vector δμ* may comprise the minimization of the sum over the projection angles of the squares of the differences between, for each projection angle, the projection residual computed for this projection angle and the product of δμ multiplied by the sensitivity fields computed for this projection angle. This corrective vector represents an error made in the estimation of the parameters contained in the vector μ and provides a quantity by which the vector μ must be modified to reduce the discrepancy between the simulated projections and the observed projections. Thus the updating of the vector μ using the corrective vector δμ* at the end of one iteration can be written μ←μ+δμ*.

For example, the corrective vector δμ* is given by

$$δ {μ}^{*} = arg {min}_{δ μ} {\sum }_{( n )} {‖ {w}^{( n )} ( x ) ( {ρ}^{( n )} ( x ; p , c , α , μ , {θ}_{ini} ) - {s}^{( n )} ( x ; μ ) δμ ) ‖}^{2}$$

where s⁽ⁿ⁾(x; μ) is the matrix of sensitivity fields s⁽ⁿ⁾(x; μₖ) and w⁽ⁿ⁾(x) is a weighting term which can be used to take into account local uncertainties, for example due to noise or dead pixels. The invention is however not limited to the solving of equations of the preceding form, but can for example be extended to regularization methods, such as Tikhonov regularization, which make it possible to introduce an element of the a priori into the problem.

In one possible implementation of step E3b, each of the iterations further comprises following the updating of the vector μ using the corrective vector δμ* and for each of the sub-parts of interest:
the generation of second simulated projections of the part corresponding to the projections computed based on the images acquired from the different projection angles, based on the reference model of the outer surface MODS, where applicable, on the reference model of the inner cavity or cavities MODC, on the vector μ updated using the corrective vector δμ* and on the vector δⱼ of the geometrical parameters of the sub-part of interest number j being considered;
the determination of a discrepancy between the second simulated projections and the projections computed based on acquired images;
the modification of the vector θⱼ for the purpose of reducing said discrepancy.

At each of the iterations, the determination of a discrepancy between the second simulated projections and the projections computed based on the acquired images may comprise, for each projection angle, the computation of a projection residual, for example as ρ⁽ⁿ⁾(x; p, c, α, μ, θⱼ)=P⁽ⁿ⁾(x)−\tilde{P}(n)(x; p, c, α, μ, θⱼ) corresponding to the discrepancy between the second simulated projection for this projection angle and the projection computed based on the image acquired for this projection angle.

Moreover, at each of the iterations, the modification of the vector θⱼ comprises:
for each projection angle, the computation of fields of sensitivity of the second simulated projection for this projection angle to a variation of the parameters contained in the vector θⱼ;
the computation of a corrective vector δθⱼ* as being the vector δθⱼ minimizing a discrepancy between the projection residuals and the product of δθⱼ multiplied by the sensitivity fields;
the updating of the vector θⱼ using the corrective vector δθⱼ*.

The field of sensitivity of a simulated projection to a variation of a parameter θ_{j,k} of the vector θⱼ is expressed for example as

$${s}^{( n )} ( x ; {θ}_{j , k} ) = \frac{\partial {\tilde{P}}^{( n )} ( x ; p , c , α , μ , {θ}_{j} )}{\partial {θ}_{j , k}} .$$

The computation of the corrective vector δθⱼ* may comprise the minimization of the sum over the projection angles of the squares of the differences between, for each projection angle, the projection residual computed for this projection angle and the product of δθⱼ multiplied by the sensitivity fields computed for this projection angle. This corrective vector represents an error made in the estimation of the parameters contained in the vector θⱼ and provides a quantity by which the vector θⱼ must be modified to reduce the discrepancy between the simulated projections and the projections computed based on acquired images. Thus the updating of the vector θⱼ using the corrective vector δθⱼ* at the end of one iteration can be written θⱼ←θⱼ+δθⱼ*.

For example, the corrective vector δθⱼ* is given by

$$δ {θ}_{j}^{*} = arg {min}_{δ {θ}_{j}} {\sum }_{( n )} {‖ {v}^{( n )} ( x ; j ) ( {ρ}^{( n )} ( x ; p , c , α , μ , {θ}_{j} ) - {s}^{( n )} ( x ; {θ}_{j} ) δ {θ}_{j} ) ‖}^{2}$$

where s⁽ⁿ⁾(x; θⱼ) is the matrix of the sensitivity fields s⁽ⁿ⁾(x; θ_{j,k}) and v⁽ⁿ⁾(x; j) is a weighting term.

The iterations are stopped when a criterion is verified, for example when a maximum number of iterations is reached, when the residuals computed at the end of one iteration are below a given threshold or else when the reduction of the value of the residuals between two successive iterations is below a given threshold.

In one possible embodiment of the invention, measurements of uncertainty on the value of the estimated parameters can be made. For example, a measurement of the uncertainty on the parameters δθ_{j,i}* of the corrective vector δθⱼ* is given by the coefficients of the covariance matrix C of term Cᵢₖ=<δθ_{j,i}*, δθ_{j,k}*> the value of which will depend on the assumptions in question, particularly concerning the nature and characteristics of the noise. The term

$$\sqrt{{C}_{kk}}$$

indicates the uncertainty on the k-th parameter when it is considered independently of the others. The non-diagonal terms of the covariance matrix represent the couplings between parameters.

These measurements can be computed both for the parameters contained in the vector μ and on the parameters contained in the vector or vectors δⱼ.

During a fourth step E4, the method according to the invention comprises the determination of a corrected model of the outer surface by transformation of the reference model of the outer surface by means of the vector μ resulting from the iterations and, where applicable, the determination of a corrected model of the inner cavity or cavities by transformation of the reference model of the inner cavity or cavities by means of the vector μ resulting from the iterations. Where applicable, this fourth step further comprises, for each sub-part of interest, the determination of a model of the sub-part of interest by means of the vector θⱼ resulting from the iterations.

Let us here write CAOS(v) the CAD reference model of the outer surface MODS, CAOC(v) the CAD reference model of the inner cavity or cavities MODC, and CAOθⱼ(v) the CAD reference model of the sub-part number j MODθⱼ, where v∈ [symbol] ³ is a check point of the CAD.

CAOE(v), the CAD model of the effective model MODE, is obtained based on CAOS(v), on CAOC(v) and on the parameters contained in the vector μ, and where applicable on CAOθⱼ(v) and on the parameters contained in the vectors θⱼ. One embodiment of the model CAOE(v), for example during a method of inspection of the part, is given by the following.

The effective model CAOSE(v) of the outer surface corresponding to the corrected model CAOS(T(v; μ_{d})) and the effective model CAOCE(v) of the inner cavity or cavities corresponding to the corrected model CAOC(T(v; μ_{c})) result from the transformation of the reference models using a transformation T, for example a rigid and scale transformation, depending on the parameters contained in the vectors μ_{d} and μ_{c}, such as μ=(μ_{d}, μ_{c}).

These two effective models CAOSE(v) and CAOCE(v) are then used to determine CAOE(v). For example, CAOE(v)=difference(CAOSE(v), intersection(CAOSE(v), CAOCE(v))) with the operations difference and intersection defined for the CAD models.

Where applicable, the effective model CAOθⱼE(v) of each sub-part of interest corresponding to the corrected model CAOθⱼ(T(v; θⱼ)) results from the transformation of the reference model using a transformation T depending on the parameters contained in the vector θⱼ. This transformation depends on the sub-part under consideration, for example the increase in the length or in the radius of the cylinder in the case of a drilled hole as shown in FIG. 3. With this effective model is associated an operator, written Fⱼ, modifying CAOE(v) such that Fⱼ(CAOE(v), CAOθⱼE(v)) corresponds to the effective model of the part modified by the effective model of the sub-part number j. For example, Fⱼ (CAOE(v), CAOθⱼE(v))=difference(CAOE(v), intersection (CAOE(v), CAOθⱼE(v)) with the operations difference and intersection defined for the CAD models, in the case of a drilled hole as shown in FIG. 3.

The method moreover comprises a step E5 of validation of the part which makes use of the effective model and the effective models of each sub-part of interest, for example in two different ways, firstly based on information coming directly from the effective model and from the effective models of each sub-part of interest, and secondly based on information resulting from the differences between simulated projections using the effective models and observed projections.

Geometrical indicators, which characterize the geometry of each sub-part, may be computed based on its effective model CAOθⱼE(v) and the associated uncertainties can be compared to the values stated in dimensioning documents in order to validate each sub-part.

Additionally, an examination procedure is applied to the effective model. The values obtained are compared with the values of the examination procedure applied to the reference model, taking the tolerances into account. This allows for an examination of parts of interest a posteriori to the identification of the sub-parts.

During the step E5, the effective model of the part and the parameters contained in the optimal vectors p, c, α describing the projection geometry and the image artifacts are moreover used to generate new simulated projections and evaluate their discrepancies in relation to the observed projections. The method thus comprises the following steps:
the generation of third simulated projections of the part corresponding to the attenuation projections computed based on the images acquired from the different projection angles, based on the effective model of the part;
the comparison of the projections computed based on the acquired images and the third simulated projections based on the effective model of the part.

In particular, the differences between the simulated projections based on the effective model of the part and the observed projections can be compared to a level of noise present in a projection. This measurement has the advantage of depending on the pixel under consideration. If the differences are less than the level of noise, then they are considered as insignificant. If not, this means that the effective model was not able to capture the variability of shape needed for this comparison.

1. A method of non-destructive testing of a part comprising the steps of:
computing projections based on images of the part acquired from different projection angles by an X-ray radiography device;
at each of several iterations:
generating first simulated projections of the part corresponding to the projections computed based on the images acquired from the different projection angles, based on a reference model of an outer surface of the part and on a vector μ of parameters of transformation of the reference model of the outer surface;
determining discrepancy between the first simulated projections and the projections computed based on the acquired images;
modifying the vector μ for the purpose of reducing said discrepancy;
determining corrected model of the outer surface by transformation of the reference model of the outer surface by means of the vector μ resulting from the iterations;
determining an effective model of the part by means of the corrected model of the outer surface.

2. The method as claimed in claim 1,
wherein generating, at each of the iterations, the first simulated projections is also done based on a reference model of one or more inner cavities of the part and wherein the vector μ also comprises parameters of transformation of the reference model of the inner cavity or cavities;
further comprising determining a corrected model of the inner cavity or cavities by transformation of the reference model of the inner cavity or cavities by means of the vector μ resulting from the iterations; and
wherein determining the effective model of the part is also done by means of the corrected model of the inner cavity or cavities.

3. The method as claimed in claim 1, wherein at each of the iterations:
determining a discrepancy between the first simulated projections and the projections computed based on the acquired images comprises, for each projection angle, computing a projection residual corresponding to the discrepancy between the first simulated projection for this projection angle and the projection computed based on the image acquired for this projection angle; and
modifying the vector μ comprises:
for each projection angle, computing fields of sensitivity of the first simulated projection for this projection angle to a variation of the parameters contained in the vector μ;
computing a corrective vector δμ* as being the vector δμ minimizing a discrepancy between the projection residuals and the product of δμ multiplied by the sensitivity fields;
updating the vector μ using the corrective vector δμ*.

4. The method as claimed in claim 3, wherein computing the corrective vector δμ* comprises minimizing the sum over the projection angles of the squared norms of the weighted differences between, for each projection angle, the projection residual computed for this projection angle and the product of δμ multiplied by the sensitivity fields computed for this projection angle.

5. The method as claimed in claim 1, wherein each iteration further comprises following modifying the vector μ:
generating second simulated projections of the part corresponding to the projections computed based on the images acquired from the different projection angles, based on the reference model of the outer surface, on a model of a j-th sub-part of interest of the part, on the modified vector μ and on a vector θⱼ of geometrical parameters of the j-th sub-part of interest of the part;
determining a discrepancy between the second simulated projections and the projections computed based on the acquired images;
modifying the vector θⱼ for the purpose of reducing said discrepancy.

6. The method as claimed in claim 5, wherein at each of the iterations:
determining a discrepancy between the second simulated projections and the projections computed based on the acquired images comprises, for each projection angle, computing a projection residual corresponding to the discrepancy between the second simulated projection for this projection angle and the projection computed based on the image acquired for this projection angle; and
modifying the vector θⱼ comprises:
for each projection angle, computing fields of sensitivity of the second simulated projection for this projection angle to a variation of the parameters contained in the vector θⱼ;
computing a corrective vector δθⱼ* as being the vector δθⱼ minimizing a discrepancy between the projection residuals and the product of δθⱼ multiplied by the sensitivity fields;
updating the vector θⱼ using the corrective vector δθⱼ*.

7. The method as claimed in claim 6, wherein computing the corrective vector δθⱼ* comprises minimizing the sum over the projection angles of the squared norms of the weighted differences between, for each projection angle, the projection residual computed for this projection angle and the product of δθⱼ multiplied by the sensitivity fields computed for this projection angle.

8. The method as claimed in claim 5, further comprising determining a corrected model of the j-th sub-part of interest by transformation of the reference model of the i-th sub-part of interest by means of the vector θⱼ resulting from the iterations and wherein determining the effective model of the part is also done by means of the corrected model of the j-th sub-part of interest.

9. The method as claimed in claim 1, wherein generating the first simulated projections is furthermore done based on a vector p of parameters characterizing the projection geometry of the acquisition.

10. The method as claimed in claim 9, further comprising, by means of a vector of parameters of a model of image artifacts, a correction of artefacts in the projections computed based on the acquired images or a generation of artifacts in the first simulated projections.

11. The method as claimed in claim 1, further comprising a validation of the part by means of the effective model of the part.

12. The method as claimed in claim 11, wherein the validation of the part comprises:
generating third simulated projections of the part corresponding to the projections computed based on the images acquired from the different projection angles, based on the effective model of the part;
comparing the projections computed based on the acquired images and the third simulated projections based on the effective model of the part.

13. A system of non-destructive testing based on the volume modeling of a part, comprising:
an X-ray radiography device capable of acquiring images of attenuation of the part from different projection angles; and
a processor configured to carry out the steps of:
computing projections based on the images acquired from the different projection angles;
at each of several iterations:
generating first simulated projections of the part corresponding to the projections computed based on the images acquired from the different projection angles, based on a reference model of an outer surface of the part and on a vector μ of parameters of transformation of the reference model of the outer surface;
determining a discrepancy between the first simulated projections and the projections computed based on the acquired images;
modifying the vector μ for the purpose of reducing said discrepancy;
determining a corrected model of the outer surface by transformation of the reference model of the outer surface by means of the vector μ resulting from the iterations;
determining an effective model of the part by means of the corrected model of the outer surface.

14. A non-transitory computer-readable medium storing instructions which, when executed by a computer, cause the computer to implement the method of claim 1.
